(19) United States
(12) Patent Application Publication
(10) Pub. No.: US 2005/0201225 A1
(43) Pub. Date: Sep. 15, 2005

(54) Optical disk drive capable of adjusting control information to recording layer

(76) Inventor: Toshiyuki Kase, Kanagawa (JP)

Correspondence Address: DICKSTEIN SHAPIRO MORIN & OSHINSKY LLP, 2101 L Street, NW, Washington, DC, 20037, US

(21) Appl. No.: 11/066,794

(22) Filed: Feb. 28, 2005

(30) Foreign Application Priority Data
Mar. 1, 2004 (JP) NO. 2004-055631

(51) Int. Cl. G11B 7/00

(52) U.S. Cl. 369/44.28; 369/44.32

(57) ABSTRACT

An optical disk drive is disclosed including an optical system, a servo signal detector configured to obtain control information for controlling the optical system based on the output signal of a photo detector in accordance with the recording layer to be accessed, a servo controller configured to select adjustment information in accordance with the recording layer, and adjust the control information based on the selected adjustment information. When the optical disk drive accesses an optical disk having multiple recording layers, the servo signal detector can obtain the control information for controlling the optical system in accordance with the recording layer, and the servo controller can select adjustment information in accordance with the recording layer and adjust the control information based on the selected adjustment information. The above arrangements allows the optical system to be adjusted in accordance with the recording layer to be accessed.

### BACKGROUND OF THE INVENTION

1. Field of the Invention

The present invention generally relates to an optical disk drive, and more particularly, to an optical disk drive that can write and/or read data from an optical disk having multiple recording layers.

2. Description of the Related Art

Development in digital technology and data compression technology has enabled an optical disc such as a digital versatile disc (DVD) to store information (hereinafter referred to as content) such as music, movies, pictures and computer programs. Optical disk drives that can read and write content on optical discs are widely used.

In an optical disk drive, a laser beam is emitted from a light source, and is converged by an optical lens forming a small spot on a recording layer of an optical disk. A spiral track or concentric tracks are formed on the optical disk. The optical disk drive detects reflective light from the optical disk, and reads data and/or control the position of the optical lens, for example, based on the reflective light. The adjustment of objective lens position in the direction of light axis is referred to as focus control. (See cited references 1 through 3, for example).

It is desired that the amount of content stored in a single optical disk is increased. One technique to increase the capacity of an optical disk is to provide multiple recording layers in the optical disk (hereinafter referred to as a multilayer disk). The multilayer disk and an optical disk drive for the multilayer disk are under development.

A multilayer disk has multiple recording layers having different distances from the surface of the multiplayer disk. It is possible that optical spots formed on the multiple recording layers differ in shape, for example, due to the spherical aberration of the objective lens. An optical disk drive for multilayer disk is proposed that can adjust the spherical aberration of the object lens (see cited reference 4, for example).

The optical disk drive according to the cited reference 4 is provided with a focal point adjustment lens between the object lens and the optical disk for adjusting the spherical aberration. Because the focal point adjustment lens is moved depending on which recording layer the light spot is to be formed, this technique requires additional parts and steps for assembly and adjustment. Such additional requirements may affect the size and cost of the optical disk drive.

The following documents are cited: (1) Japanese Laid-Open Patent Application No. 2002-50056, (2) Japanese Laid-Open Patent Application No. 2002-288851, (3) Japanese Laid-Open Patent Application No. 2003-132558, and (4) Japanese Laid-Open Patent Application No. 2001-155371.

### SUMMARY OF THE INVENTION

Accordingly, it is a general object of the present invention to provide a novel and useful optical disk drive in which at least one of the above problems is eliminated.

Another and more specific object of the present invention is to provide an optical disk drive that can accurately access an optical disk having multiple recording layers without impacting the size and cost thereof.

To achieve at least one of the above objects, an optical disk drive according to the present invention includes:
a light source;
an optical system configured to guide a light beam emitted by the light source to an optical disk having a plurality of recording layers and guide a reflective light beam from the optical disk to a light receiving position, the optical system including an objective lens configured to converge the light beam on one of the plurality of recording layers to be accessed;
a photo detector configured to receive the reflective light beam, the photo detector disposed at the light receiving position;
a servo signal detector configured to obtain control information for controlling the optical system based on an output signal of the photo detector in accordance with the recording layer to be accessed;
a servo controller configured to select adjustment information in accordance with the recording layer to be accessed, and adjust the control information based on the selected adjustment information; and
a processing apparatus configured to write data to the recording layer to be accessed.

When the optical disk drive accesses the optical disk having multiple recording layers, the servo signal detector can obtain the control information for controlling the optical system in accordance with the recording layer to be accessed, and the servo controller can select known adjustment information in accordance with the recording layer to be accessed and adjust the control information based on the selected adjustment information. According to the above arrangements, the optical system can be adjusted in accordance with the recording layer to be accessed.

Other objects, features, and advantages of the present invention will become more apparent from the following detailed description when read in conjunction with the accompanying drawings.

### BRIEF DESCRIPTION OF THE DRAWINGS

FIG. 1 is a block diagram showing an optical disk drive according to an embodiment of the present invention;

FIG. 2 is a cross section showing an optical disk having multiple recording layer;

FIG. 3 is a schematic diagram showing an optical pickup according to an embodiment of the present invention;

FIG. 4 is a block diagram showing a servo control circuit according to an embodiment of the present invention;

FIG. 5 is a flowchart showing the writing operation of the optical disk drive of FIG. 1, according to an embodiment of the present invention;

FIG. 6 is a flowchart showing an operation for obtaining the optimum tilt parameter by the optical disk drive of FIG. 1, according to an embodiment of the present invention;

FIG. 7 is a flowchart showing an operation for obtaining the optimum focus parameter by the optical disk drive of FIG. 1, according to an embodiment of the present invention;

FIG. 8 is a flowchart showing an variation of the operation for obtaining the optimum tilt parameter shown in FIG. 6; and

FIG. 9 is a flowchart showing an variation of the operation for obtaining the optimum focus parameter shown in FIG. 7.

### DETAILED DESCRIPTION OF THE PREFERRED EMBODIMENTS

The preferred embodiments of the present invention are described in detail below with reference to the drawings.

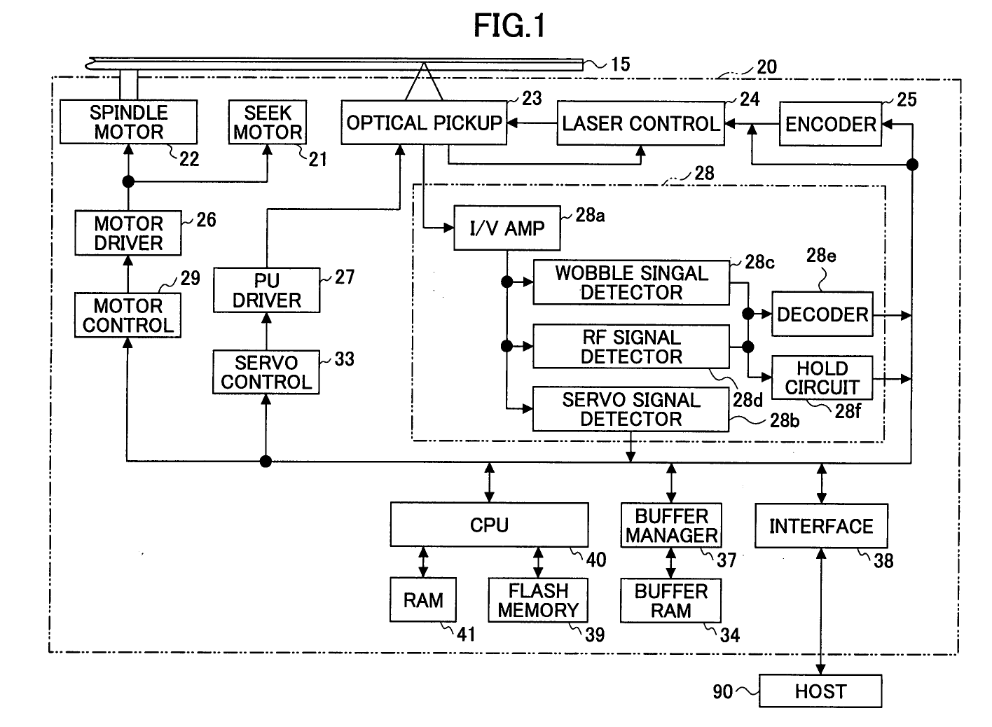

FIG. 1 shows an optical disk drive 20 according to an embodiment of the present invention. The optical disk drive 20 includes the following: a spindle motor for rotating an optical disk 15, an optical pickup 23, a seek motor 21 for actuating the optical pickup 23 in the sledge directions, a laser control circuit 24, an encoder 25, a motor driver 26, a PU driver 27, a reproduced signal processing circuit 28, a motor control circuit 29, a servo control circuit 33, a buffer RAM 34, a buffer manager 37, an interface 38, a flash memory 39, a CPU 40, and a RAM 41, for example. Allows shown in FIG. 1 indicate the flow of representative signals and information among such components in un-exhaustive manner, and it should be noted that there may be other connections among the components that are not shown in FIG. 1. The optical disk drive 20 can read data from an optical disk having multiple recording layers (multilayer disk), write data to the multilayer disk, and/or erase data written on the multilayer disk, for example.

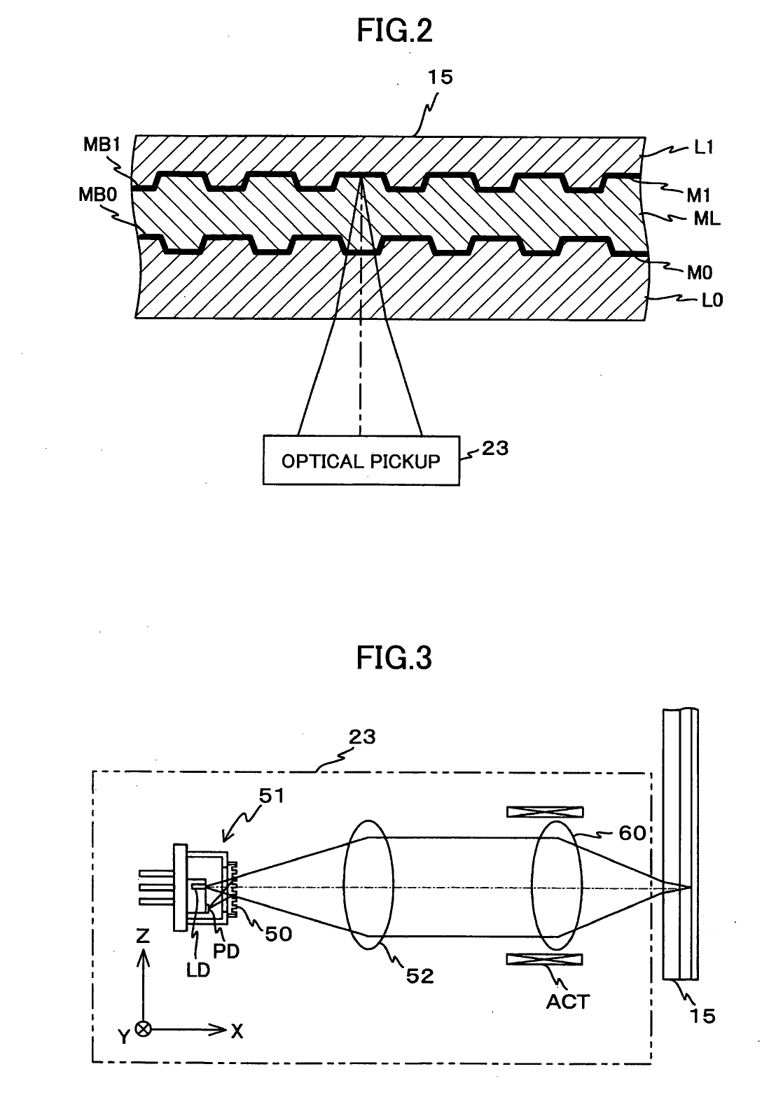

FIG. 2 shows the cross section of the optical disk 15. The optical disk includes a substrate L0, a recording layer M0, an interlayer ML, a recording layer M1, and a substrate L1, for example, in the order of distance from the optical pickup 23. A spiral track or concentric tracks are formed on each recording layer. Data are written on the track. There is a semi-transmissive layer MB0 made of silicon, silver, and aluminum, for example, between the recording layer M0 and the interlayer ML. In addition, there is a metal reflective layer MB1 made of silver and aluminum, for example, between the recording layer M1 and the substrate L1. Thus, the optical disk 15 has two recording layers (dual-layer disk). The optical disk 15 is a dual-layer recordable disk which can be written by 660 nm laser beam as DVD currently available in the market.

The optical pickup 23 emits a laser beam to one of two recording layers of the optical disk 15, and receives reflective light beam from the optical disk 15. FIG. 3 shows the structure of an exemplary optical pickup 23. The optical pickup includes a light source unit 51, a collimator lens 52, an object lens 60, and an actuator system ACT, for example.

The light source unit 51 includes a semiconductor laser LD for emitting a laser beam of 660 nm wavelength, a photo detector PD for detecting the reflective light beam from the optical disk 15, the photo detector PD being disposed near the semiconductor laser LD, and a hologram 50 for separating the reflective light beam from the optical disk 15 towards the light reception face of the photo detector PD. The light source unit 51 is aligned such that the intensity distribution of the laser beam emitted by the light source unit 51 becomes maximum in the +X direction of the optical pickup 23. The photo detector PD converts the reflective light beam from the optical disk 15 into an electrical signal, and outputs the electrical signal to the reproduced signal processing circuit 28. The output signal from the photo detector PD contains a wobble signal, a RF signal, and a servo signal, for example.

The collimator lens 52 is disposed at +X side of the light source unit 51, and makes the laser beam emitted from the light source unit 51 substantially parallel.

The object lens 60 is disposed at +X side of the collimator lens 52, and converges the laser beam from the collimator lens 52 to the recording layer to be accessed.

The actuator system ACT includes a focusing actuator, a tracking actuator, and a tilt actuator. The focusing actuator can actuate the object lens 60 in the focus directions which corresponds to the directions of the light axes of the object lens 60. The tracking actuator can actuate the object lens 60 in the tracking directions which is perpendicular to the tangential directions of the track. The tilt actuator can rotate the object lens 60 around an axis in the tangential direction of the track as a rotative axis.

Referring back to FIG. 1, the reproduced signal processing circuit 28 includes an I/V amp 28a, a servo signal detector circuit 28b, a wobble signal detector circuit 28c, a RF signal detector circuit 28d, a decoder 28e, and a hold circuit 28f, for example.

The I/V amp 28a can convert the output current signal of the photo detector PD into a voltage signal, and amplify the voltage signal at a predetermined gain.

The servo signal detector circuit 28b can detect a servo signal such as a focus error signal and a tracking error signal based on the output signal of the I/V amp 28a. The servo signal detected by the servo signal detector circuit 28b is output to the servo control circuit 33.

The wobble signal detector circuit 28c can detect a wobble signal based on the output signal of the I/V amp 28a. The RF signal detector circuit 28d can detect a RF signal based on the output signal of the I/V amp 28a.

The decoder 28e extracts address information and a sync signal from the wobble signal. The extracted address information is output to the CPU 40, while the extracted sync signal is output to the encoder 25 and the motor control circuit 29. The decoder 28e can decode the RF signal, detect any error contained in the decoded data, and if any, correct the error in the decoded data. Then, the decoded data is stored in the buffer RAM 34 via the buffer manager 37. If the decoder 28e detects a block error (Cl error) in the decoded data, the decoder 28e informs the CPU 40 of the occurrence of the block error.

The hold circuit 28f can detect the upper envelope level and the lower envelope level of the RF signal. The upper envelope level (Lp) and the lower envelope level (Lb) detected by the hold circuit 28f are output to the CPU 40. The CPU 40 computes a so-called beta value of the RF signal based on the following expression (1).
β=(Lp−Lb)/(Lp+Lb) (1)
This beta value may be used as an indicator of recording quality. The CPU 40 obtains the amplitude of the RF signal based on the output signal of the hold circuit 28f.

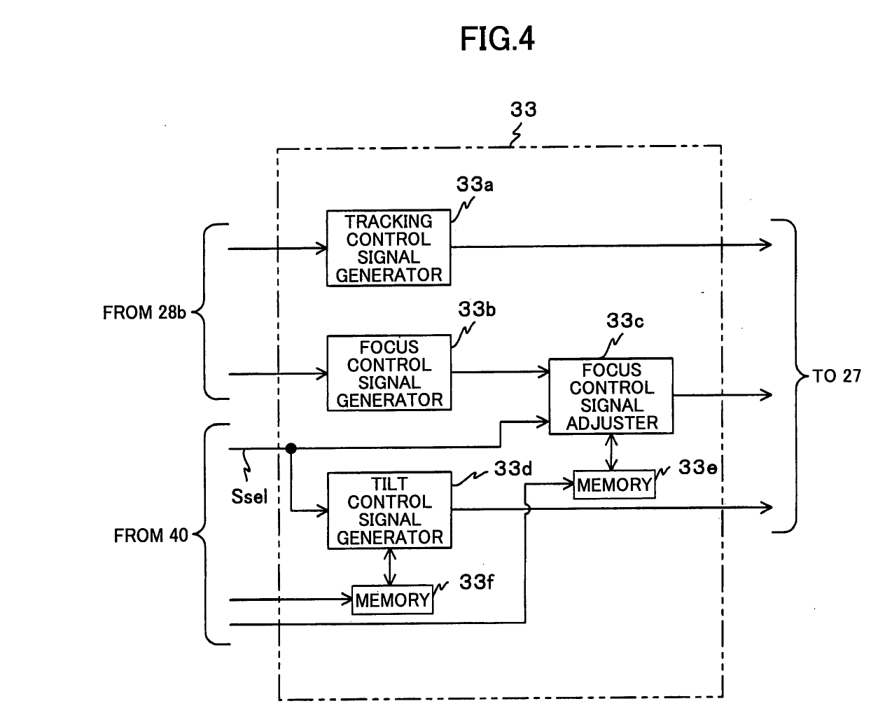

As shown in FIG. 4, the servo control circuit 33 includes a tracking control signal generator circuit 33a, a focus control signal generator circuit 33b, a focus control signal adjustment circuit 33c, a tilt control signal generator circuit 33d, and two memories 33e and 33f, for example.

The tracking control signal generator circuit 33a can generate a tracking control signal for adjusting tracking errors based on the tracking error signal from the servo signal detection circuit 28b. The tracking control signal generated by the tracking control signal generator circuit 33a is output to the PU driver 27.

The focus control signal generator circuit 33b can generate a focus control signal for adjusting focus errors based on the focus error signal of the servo signal detector circuit 28b. The focus control signal generated by the focus control signal generator circuit 33b is output to the focus control signal adjustment circuit 33c.

The memory 33e stores the optimum focus parameter (adjustment information) for each recording layer. The optimum focus parameter is described in more detail below.

The focus control signal adjustment circuit 33c retrieves the optimum focus parameter from the memory 33e based on a recording layer signal Ssel indicating the recording layer to be accessed, and adjusts the focus control signal. The adjusted focus control signal is output to the PU driver 27.

The memory 33f stores the optimum tilt parameter (adjustment information) for each recording layer. The optimum tilt parameter is described in more detail below.

The tilt control signal generator circuit 33d retrieves the optimum tilt parameter from the memory 33f based on the recording layer signal Ssel indicating the recording layer to be accessed, and generates the tilt control signal. The tilt control signal generated by the tilt control signal generator circuit 33d is output to the PU driver 27.

The PU driver 27 generates a driving signal for the focus actuator corresponding to the adjusted focus control signal. The PU driver 27 further generates a driving signal for the tracking actuator corresponding to the tracking control signal. The PU driver 27 further generates a driving signal for the tilt actuator corresponding to the tilt control signal. The driving signals generated by the PU driver 27 are output to the optical pickup 23.

Referring back to FIG. 1, the motor control circuit 29 a rotation control signal for controlling the rotation of the spindle motor 22 based on an instruction of the CPU 40. The motor control circuit 29 further generates a seek control signal for controlling the seek motor 21 based on an instruction of the CPU 40. The control signals generated by the motor control circuit 29 are output to the motor driver 26.

The motor driver 26 generates a driving signal corresponding to the rotation control signal, and outputs the driving signal to the spindle motor 22. The motor driver 26 further generates a driving signal corresponding to the seek control signal, and outputs to the seek motor 21.

The buffer RAM 34 buffers data to be written on the optical disk 15 (write data), and data read from the optical disk 15 (reproduced data). The input and output of data to the buffer RAM 34 is controlled by the buffer manager 37.

The encoder 25 retrieves the write data stored in the buffer RAM 34 via the buffer manager 37 based on an instruction of the CPU 40. The encoder 25 further modulates the write data, adds error correction codes thereto, and generates a writing signal to be written on the optical disk 15. The writing signal is output to the laser control circuit 24.

The laser control circuit 24 controls the power of a laser beam emitted by the semiconductor laser LD. When writing data to the optical disk 15, the laser control circuit 24 generates a driving signal for the semiconductor laser LD based on the writing signal, writing condition, and the optical properties of the semiconductor laser LD. The peak value of the laser power emitted by the semiconductor laser LD during writing operation may be referred to as writing power.

The interface 38 is a bi-directional communication interface to which a host 90 such as a personal computer is connected. The interface 38 may comply with a standard interface such as AT Attachment Packet Interface (ATAPI) and Small Computer System Interface (SCSI). During reading operation, the reproduced data stored in the buffer RAM 34 is output sector by sector to the host 90 via the interface 38. In addition, during writing operation, user data is provided from the host 90 via the interface 38, and buffered in the buffer RAM 34 via the buffer manager 37 as the write data.

The flash memory 39 includes a program region and a data region. The program region of the flash memory 39 stores computer programs expressed by codes that the CPU 40 can read and execute. The data region of the flash memory 39 stores the recording condition and the optical properties of the semiconductor laser LD, for example.

The CPU 40 controls the other components of the optical disk drive 20 in accordance with the computer programs stored in the program region of the flash memory 39, and stored control data required for the control, for example, in the memories 33e and 33f, the RAM 41, and the buffer RAM 34.

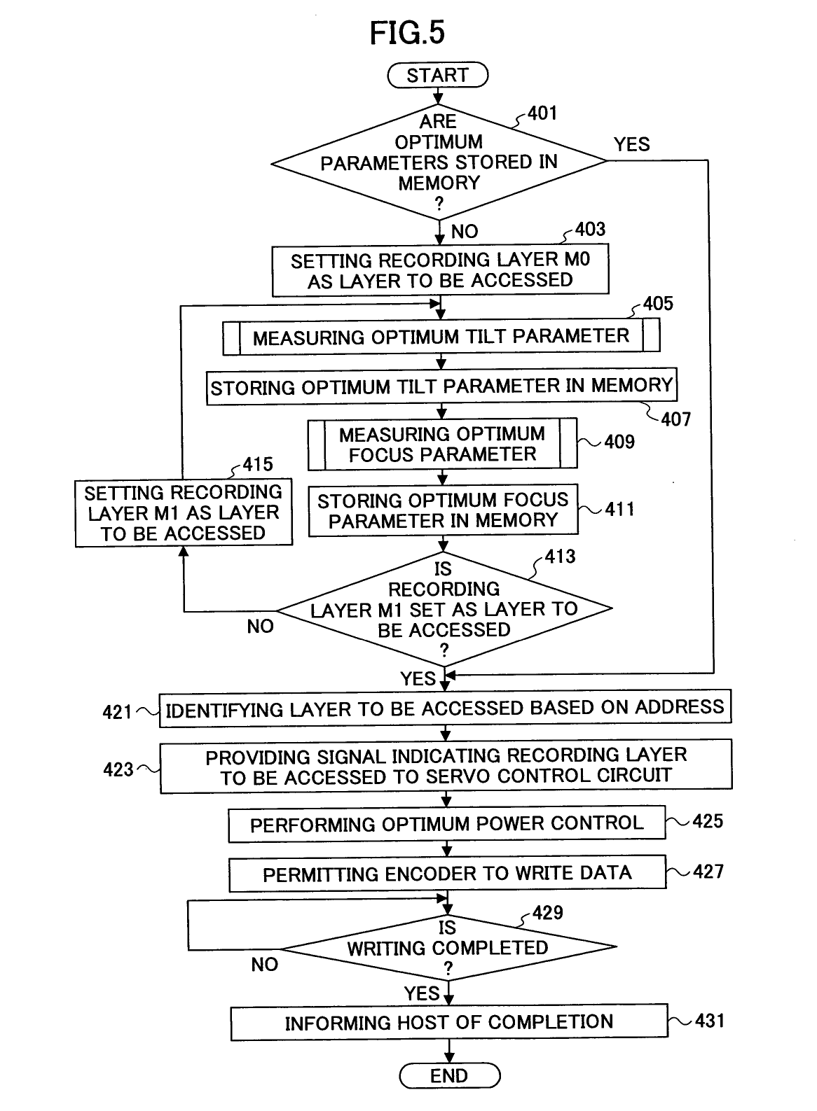

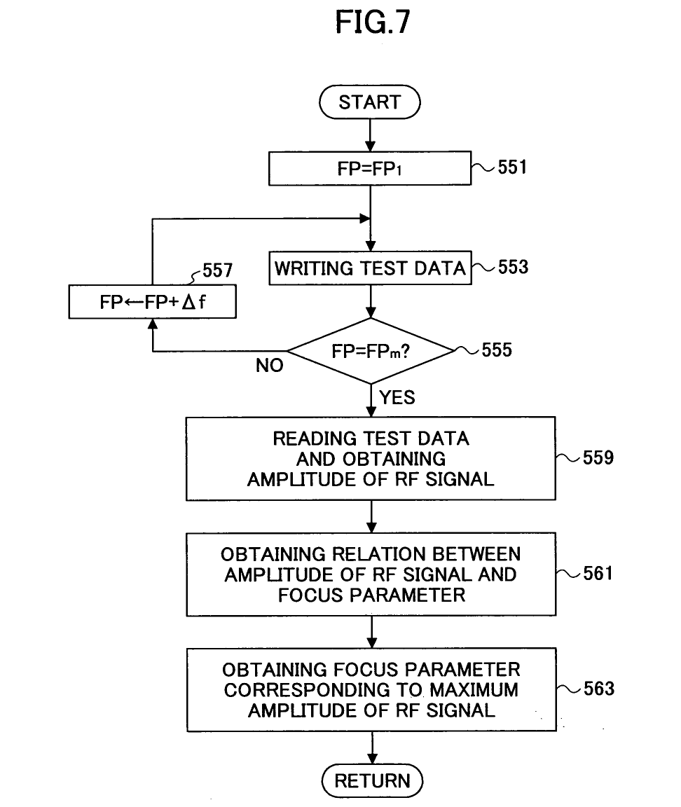

The operation of the optical disk driver 20 in response to receipt of a request from the host 90 for writing data in the optical disk 15 is described in detail with reference to FIGS. 5 through 7. Flowcharts in FIGS. 5 through 7 correspond to the processing of the CPU 40. In response to receipt of the request from the host 90 for writing data, the top address of a computer program corresponding to the flowchart shown in FIG. 5 is set to the program counter of the CPU 40, and the CPU 40 starts processing.

In the initial step 401, the CPU 40 access the memories 33e and 33f, and determines whether the optimum tilt parameter of each recording layer and the optimum focus parameter of each recording layer have been already obtained. If the optimum parameter has not been obtained yet, the process proceeds to step 403.

In step 403, the CPU 40 sets the recording layer M0 as the recording layer to be accessed.

In step 405, the CPU 40 measures the optimum tilt parameter. This step is described in more detail below.

In step 407, the CPU 40 stores the measured optimum tilt parameter in conjunction with the information of the recording layer to be accessed in the memory 33f.

In step 409, the CPU 40 measures the optimum focus parameter. This step is described in more detail below.

In step 411, the CPU 40 stores the measured optimum focus parameter in conjunction with the information of the recording layer to be accessed in the memory 33e.

In step 413, it is determined whether the recording layer to be accessed is the recording layer M1. In the current situation, the recording layer to be accessed is the recording layer M0, the determination is negative. The process proceeds to step 415.

In step 415, the CPU 40 sets the recording layer M1 as the recording layer to be accessed. That is, the CPU 40 performs a focus jump. The process returns to step 405.

Steps 405 through 411 are then repeated. The recording layer to be accessed is currently the recording layer M1, and the determination of step 413 is affirmative in this time. The process proceeds to step 421.

In step 421, the CPU 40 identifies the recording layer in which the user data is stored based on the address contained in the write request from the host 90, and sets the identified recording layer as the recording layer to be accessed.

In step 423, a recording layer signal Ssel indicating the recording layer to be accessed is output to the focus control signal adjustment circuit 33c and the tilt control signal generator circuit 33d, for example. The recording layer signal Ssel allows the position and attitude of the object lens 60 to be adjusted in accordance with the recording layer to be accessed.

In step 425, the CPU 40 performs Optimum Power Control (OPC). That is, the CPU 40 writes test data in a Power Calibration Area (PCA) with write power being changed step-wise, reads the test data written in the PCA, and obtains the beta value as described above for each write power. The CPU 40 determines that the test data that results in the beta value substantially matching a target value that has been experimentally obtained in advance is of the best quality, and further determines the write power with which the test data of the best quality is written as the optimum write power.

In step 427, the CPU 40 allows the encoder 25 to write data on the optical disk 15. The encoder 25 start writing the write data to the optical disk 15 via the laser control circuit 24 and the optical pickup 23.

In step 429, the CPU 40 determines whether the writing of the write data has been completed. If not, the determination is negative, and step 429 is repeated until the writing of the write data is completed. When the write data is completely written in the optical disk 15, the determination in step 429 becomes affirmative, the process proceeds to step 431.

In step 431, the CPU 40 informs that the write data has been completely written to the optical disk 15. After ending processing, the process is terminated.

If a determination is made that the optimum parameters has been obtained in step 401, the determination is affirmative, and the process proceeds to step 421.

[Measurement of Optimum Tilt Parameter]

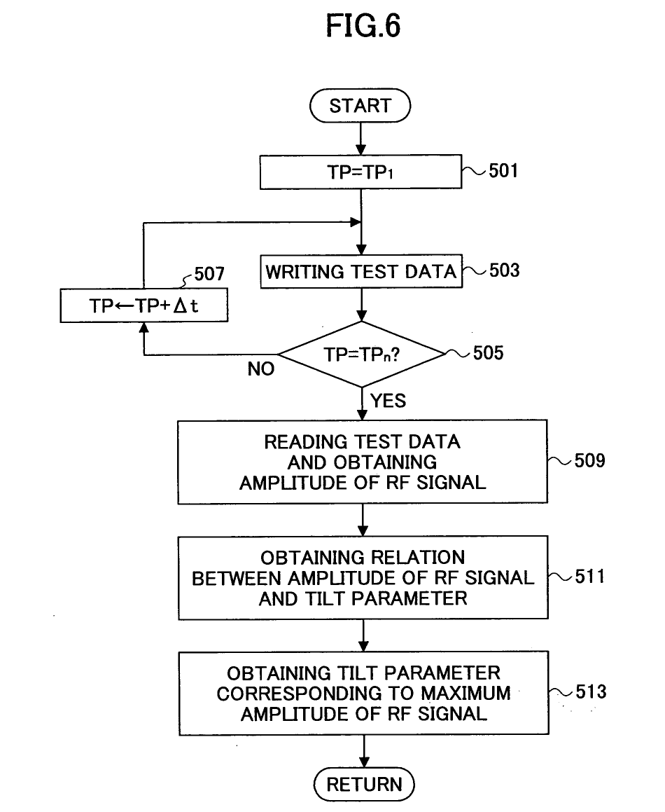

Step 405 in the previous flowchart shown in FIG. 5 is further described in more detail with reference to the flowchart shown in FIG. 6. An exemplary operation is described below in which the tilt parameter (TP) is increased step-wise from TP1 by Δt up to TPn.

In the initial step 501, the tilt parameter TP is set at TP1.

In step 503, predetermined test data are written in a test area.

In step 505, it is determined whether the tilt parameter TP is TPn or not. In the current situation, the tilt parameter TP is TP1, the determination is negative. The process proceeds to step 507.

In step 507, the tilt parameter TP is increased by Δt, and step 503 is repeated.

Steps 503, 505, and 507 are repeated in the same manner until the determination of step 505 turns to be affirmative.

If the tilt parameter TP becomes TPn, the determination in step 505 turns to be affirmative, and the process proceeds to step 509.

In step 509, the test data written in the test area are reproduced. The amplitude of the RF signal is obtained based on the output signal of the hold circuit 28f.

In step 511, an approximate equation of the relation between the amplitude of the RF signal and the tilt parameter is obtained.

In step 513, a tilt parameter corresponding to the maximum amplitude of the RF signal is obtained based on the approximate equation. The obtained tilt parameter is the optimum tilt parameter. The measurement of the optimum tilt parameter is completed, and the process proceeds to step 407 in the previous flowchart.

[Measurement of the Optimum Focus Parameter]

Step 409 in the previous flowchart shown in FIG. 5 is further described in more detail with reference to the flowchart shown in FIG. 6. An exemplary operation is described below in which the focus parameter (FP) is increased step-wise from FP1 by Δf up to FPn.

In the initial step 551, the focus parameter FP is set at FP1.

In step 553, predetermined test data are written in a test area.

In step 555, it is determined whether the focus parameter FP is FPn or not. In the current situation, the focus parameter FP is FP1, the determination is negative. The process proceeds to step 557.

In step 557, the focus parameter FP is increased by Δf, and step 553 is repeated.

Steps 553, 555, and 557 are repeated in the same manner until the determination of step 555 turns to be affirmative.

If the focus parameter FP becomes FPn, the determination in step 555 turns to be affirmative, and the process proceeds to step 559.

In step 559, the test data written in the test area are reproduced. The amplitude of the RF signal is obtained based on the output signal of the hold circuit 28f.

In step 511, an approximate equation of the relation between the amplitude of the RF signal and the focus parameter is obtained.

In step 513, a focus parameter corresponding to the maximum amplitude of the RF signal is obtained based on the approximate equation. The obtained focus parameter is the optimum focus parameter. The measurement of the optimum focus parameter is completed, and the process proceeds to step 411 in the previous flowchart.

As described above, the optical disk drive 20 according to the embodiment receives a write request from the host 90, identifies a recording layer of the optical disk 15 to which user data is to be written based on the received write request, sets the identified recording layer as the recording layer to be accessed. The optical disk drive 20 then adjusts the focus control signal obtained from a focus error signal based on the optimum focus parameter corresponding to the recording layer to be accessed. The optical disk drive 20 further adjusts the tilt control signal based on the optimum til parameter corresponding to the recording layer to be accessed. Thus, the position and attitude of the object lens 60 is adjusted in accordance with the recording layer to be accessed. According to the above arrangements, the optical disk drive 20 can improve the quality (shape for example) of the light spot formed on the recording layer whichever recording layer of the optical disk 15 the light spot is formed. As a result, it is possible to accurately access to any one of the multiple layers of the optical disk 15 without increasing the size and cost of the optical disk drive.

If the optimum tilt parameter and optimum focus parameter of each recording layer have not been obtained yet, the optical disk drive 20 measures the optimum parameters of each recording layer when writing operation is started.

In the above embodiment, the optical disk drive 20 obtains the optimum parameters in response to receipt of a write request from the host 90. However, according to another embodiment, the optimum parameters may be obtained in the assembly process, inspection process, or adjustment process of the optical disk drive 20, and be stored in the memories. According to yet another embodiment, the optical disk drive 20 may obtain the optimum parameters when the optical disk 15 is set therein, and store the obtained optimum parameters in the memories.

In the above embodiment, the optimum parameters are obtained based on the amplitude of the RF signal. In another embodiment, jitter and block error rate (BLER) may be used instead.

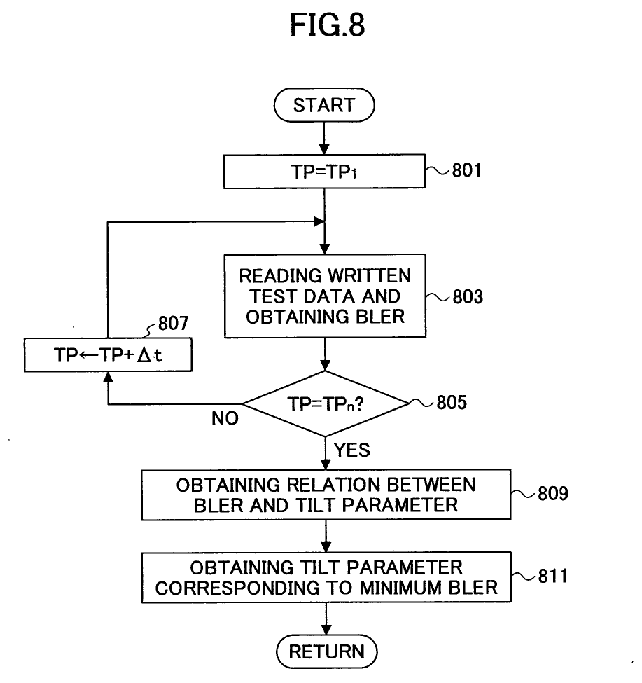

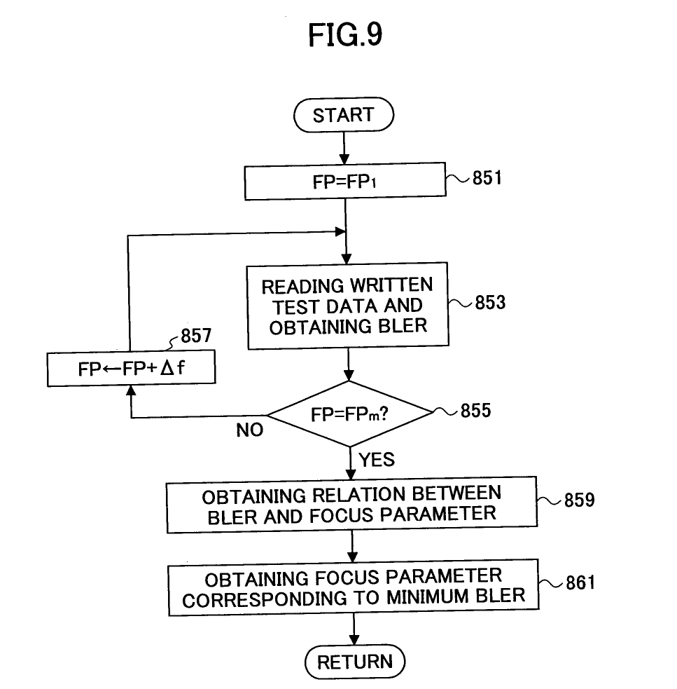

In addition, in the above embodiment, when the optimum tilt data is obtained, the test data is written in a test area. In another embodiment, the optimum tilt parameter may be obtained by reading data written in a predetermined area. Such case is described below with reference to FIG. 8.

In the initial step 801, the tilt parameter TP is set at TP1.

In step 803, data written in a predetermined area is reproduced, and BLER is obtained based on block error information from the decoder 28e.

In step 805, a determination is made whether the tilt parameter TP is TPn. In the current situation, the tilt parameter TP is TP1, thus the determination is negative. The process proceeds to step 807.

In step 807, the tilt parameter TP is increased by Δt, and the process returns to step 803.

Until the determination in step 805 turns to be affirmative, steps 803, 805, and 807 are repeated.

If the tilt parameter TP is TPn in step 805, the determination becomes affirmative. The process proceeds to step 809.

In step 809, an approximate equation of the relation between the BLER and the tilt parameter is obtained.

In step 811, a tilt parameter corresponding to the minimum BLER is obtained based on the approximate equation. The obtained tilt parameter is the optimum tilt parameter. The measurement of the optimum tilt parameter is completed.

In the above measurement, the jitter of the RF signal may be used instead of the BLER.

In addition, in the above embodiment, when the optimum focus data is obtained, the test data is written in a test area. In another embodiment, the optimum focus parameter may be obtained by reading data written in a predetermined area. Such case is described below with reference to FIG. 8.

In the initial step 851, the focus parameter FP is set at FP1.

In step 853, data written in a predetermined area is reproduced, and BLER is obtained based on block error information from the decoder 28e.

In step 855, a determination is made whether the focus parameter FP is FPn. In the current situation, the focus parameter FP is FP1, thus the determination is negative. The process proceeds to step 857.

In step 857, the focus parameter FP is increased by Δf, and the process returns to step 853.

Until the determination in step 855 turns to be affirmative, steps 853, 855, and 857 are repeated.

If the focus parameter FP is FPn in step 855, the determination becomes affirmative. The process proceeds to step 859.

In step 859, an approximate equation of the relation between the BLER and the focus parameter is obtained.

In step 811, a focus parameter corresponding to the minimum BLER is obtained based on the approximate equation. The obtained focus parameter is the optimum focus parameter. The measurement of the optimum focus parameter is completed.

In the above measurement, the jitter of the RF signal may be used instead of the BLER.

As shown in FIG. 3, the photo detector PD, the semiconductor laser LD, and the hologram 50 are disposed in a package. However, according to another embodiment, the three components may be disposed separately in different packages. According to yet another embodiment, the hologram 50 may be replaced with a beam splitter.

As shown in FIG. 2, the optical disk 15 has 2 recording layers. However, according to another embodiment, an optical disk may have three recording layers or more.

In the above embodiment, the optical disk drive 20 and the optical disk 15 are assumed to comply with the DVD standard. However, the optical disk drive according to the present invention may comply with another standard such as Compact Disk (CD) and a next generation recording medium which uses 405 nm laser beam.

It should be understood by those skilled in the art that the optical disk drive according to the present invention can read and write data to an optical disk having a single recording layer (single layer disk). In such a case, the optical disk drive can obtain at least one of the optimum focus parameter and the optimum tilt parameter of the single recording layer, and adjust the servo signal for the object lens.

In the above embodiments, the optical disk drive adjusts both the focus and tilt of the object lens in accordance with the recording layer. However, according to another embodiment, the optical disk drive according to the present invention may adjust either the focus or the tilt of the object lens. In the case in which the optical disk drive only adjusts the focus of the object lens, the tilt actuator described above may not be needed.

In the above embodiment, the optical pickup is provided with a semiconductor laser. However, according to another embodiment, the optical pickup may include multiple semiconductor lasers that can emit laser beams of different wavelength. The multiple semiconductor lasers may include semiconductor lasers that can emit laser beams of 405 mm, 660 nm, or 780 nm wavelengths. That is, the optical disk drive may support optical disks which comply with different standards.

In the above embodiment, the processes described in the flowcharts shown in FIGS. 5 through 8 are performed by the CPU 40. However, a portion of the processes or the entire processes may be performed by a properly structured hardware.

The preferred embodiments of the present invention are described above. The present invention is not limited to these embodiments, but variations and modifications may be made without departing from the scope of the present invention.

This patent application is based on Japanese priority patent application No. 2004-55631 filed on Mar. 1, 2004, the entire contents of which are hereby incorporated by reference.

1. An optical disk drive, comprising:
a light source;
an optical system configured to guide a light beam emitted by said light source to an optical disk having a plurality of recording layers and guide a reflective light beam from the optical disk to a light receiving position, said optical system including an objective lens configured to converge the light beam on one of the plurality of recording layers to be accessed;
a photo detector configured to receive the reflective light beam, said photo detector disposed at the light receiving position;
a servo signal detector configured to obtain control information for controlling said optical system based on an output signal of said photo detector in accordance with the recording layer to be accessed;
a servo controller configured to select adjustment information in accordance with the recording layer to be accessed, and adjust the control information based on the selected adjustment information; and
a processing apparatus configured to write data to the recording layer to be accessed.

2. The optical disk drive as claimed in claim 1, wherein the adjustment information includes one of adjustment information of the position of the object lens in focus directions and adjustment information of the tilt of the object lens against the optical disk.

3. The optical disk drive as claimed in claim 1, further comprising a controller configured to obtain the adjustment information.

4. The optical disk drive as claimed in claim 3, wherein said controller is further configured to obtain the adjustment information for each recording layer of the optical disk.

5. The optical disk drive as claimed in claim 4, said controller is further configured to write test data in a predetermined region of the optical disk using additional information in addition to the control information of said optical system, the additional information being changed, read the written test data, and determine the additional information which makes the quality of the read test data satisfy a predetermined condition as the adjustment information.

6. The optical disk drive as claimed in claim 4, said controller is further configured to read test data written in a predetermined region of the optical disk using additional information in addition to the control information of said optical system, the additional information being changed, and determine the additional information which makes the quality of the read test data satisfy a predetermined condition as the adjustment information.

7. The optical disk drive as claimed in claim 4, wherein said controller is configured to obtain the adjustment information in an assembly process, an inspection process, or an adjustment process of the optical disk.

8. The optical disk drive as claimed in claim 4, wherein said controller is further configured to obtain the adjustment information when the optical disk is set in the optical disk drive.

9. The optical disk drive as claimed in claim 4, wherein said controller is further configured to obtain the adjustment information when data is written on the optical disk.

10. An optical disk drive, comprising:
a light source;
an optical system configured to guide a light beam emitted by said light source to an optical disk having a plurality of recording layers and guide a reflective light beam from the optical disk to a light receiving position, said optical system including an objective lens configured to converge the light beam on one of the plurality of recording layers to be accessed;
a photo detector configured to receive the reflective light beam, said photo detector disposed at the light receiving position;
means for obtaining control information for controlling said optical system based on an output signal of said photo detector in accordance with the recording layer to be accessed;
means for adjusting the control information based on the selected adjustment information by selecting adjustment information in accordance with the recording layer to be accessed; and
a processing apparatus configured to write data to the recording layer to be accessed.

11. In an optical disk drive that can access a plurality of recording layers of an optical disk, a method of adjusting control information for controlling an optical system, the method comprising the steps of:
identifying one of the plurality of recording layers to be accessed;
measuring an optimum parameter corresponding to the identified recording layer;
adjusting the control information based on the optimum parameter; and
writing data using the adjusted control information.
